(19) United States
(12) Patent Application Publication
(10) Pub. No.: US 2003/0015683 A1
(43) Pub. Date: Jan. 23, 2003

(54) Azeotrope-like compositions and a process for separating pentafluoroethane and hydrogen chloride

(76) Inventors: Rajat S. Basu, East Amherst, NY (US); Hang T. Pham, Amherst, NY (US); Rajiv R. Singh, Getzville, NY (US); Hsueh S. Tung, Getzville, NY (US)

Correspondence Address: Synnestvedt & Lechner LLP, 2600 Aramark Tower, 1101 Market Street, Philadelphia, PA, 19107-2950, US

(21) Appl. No.: 10/161,362

(22) Filed: Jun. 3, 2002

Related U.S. Application Data
(60) Provisional application No. 60/295,027, filed on Jun. 1, 2001.

(51) Int. Cl. C09K 3/00

(52) U.S. Cl. 252/1

(57) ABSTRACT

The present invention provides binary azeotrope-like compositions comprising pentafluoroethane (HFC-125) and hydrogen chloride (HCl). In addition, the invention relates to methods for removing HFC-125 or HCl from a mixture of HFC-125 and HCl by distilling the mixture to remove an azeotrope-like composition of HFC-125 and HCl in the column distillate.

### CROSS-REFERENCE TO RELATED APPLICATION

This application claims priority to provisional application serial No. 60/295,027, which was filed with the United States Patent and Trademark Office on Jun. 1, 2001 and is incorporated herein by reference.

### FIELD OF THE INVENTION

The present invention pertains to azeotropic and azeotrope-like compositions of pentafluoroethane (“HFC-125”) and hydrogen chloride (“HCl”), and the use of such compositions in methods for separating HFC-125 and HCl from mixtures of HFC-125 and HCl via azeotropic distillation.

### BACKGROUND

A number of processes for the production of HFC-125 are known. Many of such processes involve the fluorination of halogenated hydrocarbon compounds to form HFC-125. In addition to HFC-125, such processes also often produce HCl as a by-product.

Applicants have come to appreciate that both HFC-125 and HCl are desirable products from a commercial standpoint. Hydrofluorocarbons (HFCs), such as pentafluoroethane (HFC-125), have found widespread use in industry as replacements for chlorofluorocarbons (CFCs) and hydrofluorochlorocarbons (HCFCs) in a number of applications including, for example, refrigerant, aerosol propellant, blowing agent, heat transfer media, and gaseous dielectric applications. Because HFCs do not contain chlorine, they tend to be non-ozone depleting and are therefore more environmentally desirable than either CFCs or HCFCs. Thus, the production and use of HFCs, including HFC-125, is desirable.

In addition, relatively pure HCl is used, for example, in the pharmaceutical and food product industries for many applications, including, washing milk cartons or other food or pharmaceutical containers. However, to be suitable for such uses, the HCl must be substantially free of organic compounds, that is, contain less than about 100 parts per million (ppm) by weight of halocarbons in the HCl.

Accordingly, applicants have recognized that the most economically viable industrial processes for the production of HFC-125 are those from which can be obtained not only relatively pure HFC-125 as a primary product, but also, relatively pure HCl as a by-product. Unfortunately, the HCl and HFC-125 products formed via conventional HFC-125 production processes tend to be difficult to separate from each other, and from other reaction by-products/impurities, via conventional separation techniques.

Therefore, a need exists for an efficient and effective method for separating HFC-125 from HCl.

### DESCRIPTION OF THE PREFERRED EMBODIMENTS

The present invention overcomes the aforementioned need by providing azeotrope-like compositions comprising HCl and HFC-125, and by providing methods for separating HCl and/or HFC-125 from mixtures of HCl and HFC-125 via azeotropic distillation.

Applicants have discovered unexpectedly that HCl and HFC-125 can be combined to form a range of combinations or mixtures that exhibit azeotropic and azeotrope-like properties. Accordingly, in certain preferred embodiments, the present invention provides binary azeotrope-like compositions comprising HFC-125 and HCl.

In addition, applicants have further discovered that the azeotropic compositions of the present invention can be used to facilitate separation of HFC-125 and/or HCl from a mixture of HFC-125 and HCl to form a product enriched in either HFC-125 or HCl. The term “enriched” is used herein to refer to the condition during the distillation of a mixture in which the concentration of one component in either the distillate or a bottoms product is higher relative to its concentration in the mixture. In particular, applicants have recognized that in mixtures of HFC-125/HCl wherein either the HFC-125 or HCl component is present in an amount less than the azeotropic amount, that component can be separated from the mixture as a first product comprising an azeotrope-like composition in the column distillate (i.e. the overhead distillate for a continuous operation or a distillate cut in a batch operation) to leave a second, bottoms product enriched in the other component. As used herein, the term “azeotropic amount” refers generally to the amount of HCl or HFC-125 component in a provided HCl/HFC-125 mixture necessary to make the provided mixture an azeotropic HCl/HFC-125 mixture at the distillation pressure and/or temperature. That is, the azeotropic amount of HCl or HFC-125 will form an azeotrope with substantially all of the other HCl or HFC-125 present in the provided mixture.

Accordingly, in certain embodiments, the present invention provides methods for separating HFC-125 or HCl from a mixture of HFC-125 and HCl comprising providing a mixture comprising HFC-125 and HCl in which either HFC-125 or HCl is present in an amount less than the azeotrope-like amount; and distilling the mixture to separate the compound present in an amount less than the azeotropic amount as a hydrogen chloride/pentafluoroethane azeotrope-like composition in a column distillate and to produce a bottoms product enriched in the other compound.

The present invention finds particular use in producing purified HCl from mixtures of HFC-125 and HCl. Because the atmospheric boiling points of pure HFC-125 and HCl are −54° F. (−48° C.) and −121° F. (−85° C.), respectively, HFC-125 would be expected to be removed as the residue, or bottoms product, in a conventional distillation of a HFC-125/HCl mixture. Applicants have recognized, however, that because the azeotrope-like compositions of the present invention are low-boiling compositions, they can be used in mixtures, wherein the HFC-125 is present in less than the azeotropic amount, to remove the HFC-125 as an azeotrope-like composition as a column distillate while leaving a distillation bottoms product enriched in HCl. Thus, in certain embodiments, the present invention provides methods for producing purified HCl comprising providing a mixture of HFC-125 and HCl, said HFC-125 being present in an amount less than the azeotropic amount; and distilling said mixture to remove an azeotrope-like composition of HFC-125 and HCl as a column distillate and to form a bottoms product enriched in HCl.

Azeotrope-Like Compositions

The present compositions are azeotrope-like compositions. As used herein, the term “azeotrope-like” is intended in its broad sense to include both compositions that are strictly azeotropic and compositions that behave like azeotropic mixtures. From fundamental principles, the thermodynamic state of a fluid is defined by pressure, temperature, liquid composition, and vapor composition. An azeotropic mixture is a system of two or more components in which the liquid composition and vapor composition are equal at the stated pressure and temperature. In practice, this means that the components of an azeotropic mixture cannot be separated during a phase change.

Azeotrope-like compositions are constant boiling or essentially constant boiling. In other words, for azeotrope-like compositions, the composition of the vapor formed during boiling or evaporation is identical, or substantially identical, to the original liquid composition. Thus, with boiling or evaporation, the liquid composition changes, if at all, only to a minimal or negligible extent. This is to be contrasted with non-azeotrope-like compositions in which, during boiling or evaporation, the liquid composition changes to a substantial degree. All compositions of the invention within the indicated ranges as well as certain compositions outside these ranges are azeotrope-like.

The azeotrope-like compositions of the invention may include additional components that do not form new azeotrope-like systems, or additional components that are not in the first distillation cut. The first distillation cut is the first cut taken after the distillation column displays steady state operation under total reflux conditions. One way to determine whether the addition of a component forms a new azeotrope-like system so as to be outside of this invention is to distill a sample of the composition with the component under conditions that would be expected to separate a non-azeotropic mixture into its separate components. If the mixture containing the additional component is non-azeotropic or non-azeotrope-like, the additional component will fractionate from the azeotrope-like components. If the mixture is azeotrope-like, some finite amount of a first distillation cut will be obtained that contains all of the mixture components that is constant boiling or behaves as a single substance.

It follows from this that another characteristic of azeotrope-like compositions is that there is a range of compositions containing the same components in varying proportions that are azeotrope-like or constant boiling. All such compositions are intended to be covered by the terms “azeotrope-like” and “constant boiling”. As an example, it is well known that at differing pressures, the composition of a given azeotrope will vary at least slightly, as does the boiling point of the composition. Thus, an azeotrope of A and B represents a unique type of relationship, but with a variable composition depending on temperature and/or pressure. It follows that, for azeotrope-like compositions, there is a range of compositions containing the same components in varying proportions that are azeotrope-like. All such compositions are intended to be covered by the term azeotrope-like as used herein.

The present invention provides azeotrope-like compositions comprising HFC-125 and HCl. Preferably, the novel azeotrope-like compositions of the present invention comprise effective amounts of HFC-125 and HCl. The term “effective amounts” as used herein refers to the amount of each component which upon combination with the other component or components, results in the formation of the azeotrope-like composition.

In preferred embodiments of the present invention, the azeotrope-like compositions comprise, and preferably consisting essentially of, from about 0.1 to about 10 weight percent pentafluoroethane and from about 90 to about 99.9 weight percent of hydrogen chloride. Preferred compositions are characterized by a vapor pressure of about 30 psia (2 atmospheres (atm)) to about 60 psia (4 atm) at −48° C. and about 10 psia (0.7 atm) to about 20 psia (1.4 atm) at −85° C.

In more preferred embodiments, the azeotrope-like compositions comprise, and preferably consisting essentially of, from about 1 to about 4 weight percent pentafluoroethane and from about 96 to about 99 weight percent of hydrogen chloride. More preferred compositions are characterized by a boiling point of about −123° F. (−86° C.)±2° F./C. at atmospheric pressure. In even more preferred embodiments, the azeotrope-like compositions comprise, and preferably consisting essentially of, about 3 weight percent pentafluoroethane and about 97 weight percent of hydrogen chloride having a boiling point of about −123° F. (−86° C.)±2° F./C. at atmospheric pressure.

The weight percent ratio of the present azeotrope-like compositions do not vary greatly with pressure. For example the azeotrope-like ratio remains about 3 weight percent pentafluoroethane and about 97 weight percent of hydrogen chloride at a pressure of 65 psig (4.4 atm) with a boiling point of about −66° F. (−54° C.)±1° F./C.

Methods and Uses

The present invention further provides methods for separating HFC-125 or HCl from a mixture of HFC-125 and HCl, wherein one of the HFC-125 or HCl compounds is present in an amount less than the azeotropic amount. In certain preferred embodiments, the present methods comprise providing a mixture comprising pentafluoroethane and hydrogen chloride, wherein one of the HFC-125 or HCl compounds is present in an amount less than the azeotropic amount, and distilling the mixture to separate the compound present in less than the azeotropic amount as product comprsing a hydrogen chloride/pentafluoroethane azeotrope-like composition in a column distillate and to produce a second product enriched in the other compound.

The HFC-125/HCl mixture may be provided from any of a number of sources according to the present invention. For example, fluids comprising HFC-125 and HCl may be prepared manually or supplied from or in a reactor as a reaction product. In preferred embodiments, the provided mixture is a reactor effluent produced from an HFC-125 and HCl-forming reaction. Examples of suitable effluents include those produced from the liquid or vapor phase reaction of perchloroethylene (“HCC-1110”) or 1-chloro-1,2,2,2-tetrafluoroethane (“HCFC-124”) with hydrogen fluoride or from the hydrogenation of pentafluoroethane. The reactor effluents for use in the present invention may be either crude reactor effluents or treated reactor effluents. As used herein the term “crude reactor effluent” refers generally to an effluent that contains HCl, HFC-125, as well as other unreacted starting materials, reaction intermediates, and/or reaction by-products. Thus, it will be recognized by those of skill in the art that the provided mixture of the present invention may contain components including, for example, HCC-1110, hydrogen fluoride, perfluoroethane (“HFC-116”), HCFC-124, chloropentafluoroethane (“CFC-115”) and the like. The term “treated reactor effluent”, as used herein, refers to an effluent that has been treated to remove a substantial portion of the unreacted starting materials, reaction intermediates, and by products. (As used herein the term “substantial portion” refers to an amount of a component that is at least a majority, preferably about 80%, more preferably about 90%, even more preferably about 95%, or more by weight, based on the total weight of the component present in the provided mixture.) Those of skill in the art will recognize that any of a wide range of methods for removing such compounds from the reactor effluent, including, for example, distillation, water or caustic scrubbing, drying, combinations thereof, and the like, may be used.

As noted above, the provided mixture comprises HFC-125 and HCl in which either the HFC-125 or HCl is present in less than the azeotropic amount. In embodiments in which a second or bottoms product enriched in HCl is desired, the provided mixture comprises an amount of HFC-125 less than the azeotropic amount. In embodiments in which a second or bottoms product enriched in HFC-125 is desired, the provided mixture comprises an amount of HCl less than the azeotropic amount. Those of skill in the art will recognize that the azeotropic amounts of HFC-125 and HCl will vary depending on the conditions under which distillation is conducted. However, in light of the disclosure herein, those of skill in the art will be readily able to determine the azeotropic amounts for a wide range of distillation conditions.

In certain preferred embodiments, the amount of HFC-125 present in the provided mixture is less than about 10 weight %. More preferably, the amount of HFC-125 is less than about 5 weight %, and even more preferably less than about 3 weight %.

Any of a wide range of conventional distillation methods and distillation apparatus may be used in the methods of the present invention. Examples of suitable distillation methods include single or multi-stage distillations performed as either continuous or batch operations. Examples of suitable apparatus include, columns with trays, packed columns, and the like.

For certain preferred embodiments, distilling the HCl/HFC-125 mixture by passing it through the distillation apparatus provides for the removal of HFC-125 as an HCl/HFC-125 azeotrope-like composition in the column distillate. The column distillate may contain other low boiling component present originally in the provided mixture. For example, depending on the number of stages or the distillation apparatus and the reflux ratio used, an additional amount of HCl beyond that of the HCl in the azeotrope-like HCl/HFC-125 composition may be present in the column distillate. In a continuous distillation, the HFC-125 may be removed from the top of the column along with the azeotropic HCl. In a batch distillation, the HFC-125 may be removed in a distillate cut, along with azeotropic HCl. As indicated, the column distillate may also contain other low boiling components from the starting mixture as well as an excess of HCl beyond the azeotropic amount.

The conditions under which the distillation is carried out is readily determinable by one of skill in the art, based on the disclosure herein. In preferred embodiments, the distillation may be carried out at pressures of up to about 500 psia. The use of pressures at the higher end of this range (i.e. closer to 500 psia) are advantageous in that reflux may be produced with a higher temperature cooling medium which is less costly per unit of cooling. However, distillation at such pressures can be more difficult because the relative volatility of the azeotrope and the HCl and HFC-125 content of the azeotrope-like compositions decrease with increasing pressure, requiring a higher reflux ratio and/or more stages of separation. In certain more preferred embodiments, distillation is carried out at a pressure of from about 75 psia to about 200 psia.

The methods of the present invention may further comprise the step of recovering HCl from the columns distillate. Any of a wide range of methods for recovering HCl from the columns distillate may be used according to the present invention. Examples of suitable methods include extracting the HCl from the columns distillate with a polar solvent or passing the column distillate over a catalyst to convert HFC-125 into products that are more easily separated from HCl and then distilling the resulting product mixture.

In certain preferred embodiments, the recovering step comprises extracting HCl from the column distillate using a polar solvent. Any of a wide range of polar solvents can be used in the recovering step of the present invention. A particularly preferred solvent comprises water.

In certain other preferred embodiments, the recovering step comprises contacting the column distillate with a catalyst to form a product mixture and subsequently distilling the product mixture to remove the new products. Suitable catalysts for use in the recovering step include ferric chloride and chromium oxyfluoride. By contacting HFC-125 with such catalyst at a temperature greater than about 400° C., at least a portion of the HFC-125 converts to a product. The product may be chlorotrifluorometane (“CFC-13”) and/or trichlorofluoromethane (“CFC-11”). If hydrogen fluoride is present, the HFC-125 will convert mainly to CFC-13. Subsequently, the product mixture is distilled to remove the CFC-13 and/or CFC-11 as the bottoms product and a purified HCl/HFC-125 mixture, containing an amount of HFC-125 less than the azeotropic amount, as a column distillate. The column distillate is then recycled to the providing step according to the present invention.

The present invention also provides methods for producing purified HCl from a mixture of HCl and HFC-125. As used herein, the term “purified HCl” refers generally to a sample of HCl which contains lower amounts of HFC-125 than the mixture from which it is recovered. The present methods comprise providing a mixture of HCl and HFC-125 in which the amount of HFC-125 is less than the azeotropic amount; distilling the mixture to separate HFC-125 as an azeotrope-like composition and to provide a bottoms product enriched in HCl; and collecting the HCl from the bottoms product.

The providing and distillation steps for the present methods are as described above for embodiments in which the amount of HFC-125 in the provided mixture is less than the azeotropic amount.

Any of a wide range of known methods for collecting HCl from the bottoms product can be used according to the present invention. As will be recognized by those of skill in the art, the bottoms product produced according to the present methods may (or may not) contain, in addition to HCl, other high boiling components originally present in the provided mixture. Accordingly, examples of suitable methods for collecting the HCl from the bottoms product include merely removing the bottoms product from the distillation apparatus (as in a continuous distillation), collecting distillate cuts containing the HCl bottoms product (specifically in a batch distillation), extracting the HCl from the bottoms product with a polar solvent, distilling the HCl from the bottoms product, combinations of two or more of these, and the like. In light of the disclosure herein, those of skill in the art will be readily able to collect the HCl from the bottoms product according to the present invention.

The present methods of producing purified HCl may also comprise the step of recovering HCl from the column distillate. Any of the methods described above for recovering HCl from the column distillate can be used.

### EXAMPLES

The invention will be clarified further by a consideration of the following examples that are intended to be exemplary, but not limiting in any manner.

### Example 1

Pentafluoroethane and hydrogen chloride are blended to form homogeneous mixture having different compositions. The vapor pressures of the compositions are measured at −48° C. and −85° C.

Table 1 shows the vapor pressure measurements of the HFC-125/HCl compositions as a function of weight percent HFC-125 at the constant temperatures. From this data it is observed that at −48° C. the compositions exhibits azeotrope-like properties at about 2 weight percent. Based on further observations it is determined that the vapor pressure maximum of the compositions falls between about 0.5 and 3.5 weight percent HFC-125 at −48° C. It is also observed that at −85° C. the compositions exhibits azeotrope-like properties at about 3 weight percent. Based on further observations it is determined that the vapor pressure maximum of the compositions falls between about 1 and 5 weight percent HFC-125 at −85° C.

TABLE 1

| Weight percent HFC-125 | Pressure (psia) | Pressure (psia) |
|---|---|---|
| (with remainder HCl) | Temperature −48° C. | Temperature −85° C. |
| 0.0 | 45.1 | 14.7 |
| 1.8 | 47.2 | 15.0 |
| 100.0 | 14.7 | 5.2 |

The data also shows that the vapor pressure of the mixtures is higher in the indicated proportions, than HFC-125 or HCl alone.

### Example 2

Vapor-liquid equilibrium (“VLE”) data are determined from the laboratory analysis of the vapor and liquid composition of the mixtures of HCl and HFC-125 at different nominal compositions at −66° F. (−54° C.). The data in Table 2 shows that the amounts of HFC-125 in the liquid and vapor are relatively constant for the listed compositions. Accordingly, the azeotrope-like compositions are present at the listed amounts and conditions.

TABLE 2

| Wt. % HFC-125 | Pressure | Liquid Composition | Vapor Composition |
|---|---|---|---|
| (remainder is HCl) | (psia) | (Wt. % HFC-125) | (Wt. % HFC-125) |
| 0.0 | 64 | 0 | 0 |
| 1.0 | 64 | 1 | 1 |
| 3.0 | 65 | 3 | 3 |
| 5.0 | 64 | 5 | 4 |

### Example 3

A mixture containing 99 weight percent HCl and 1 weight percent HFC-125 is charged to a batch distillation column operating at 1 atm pressure. After operating the column on total reflux for 8 hours, a sample (#1) of the distillate is analyzed and then two more separate distillate products (#2 and #3) are collected in succession. The overhead temperature remains constant at −123° F. (−86° C.). The three samples are analyzed by gas chromatography as was a sample of the remaining material in the reboiler. The analytical results are provided in Table 3.

TABLE 3

| | Total reflux | | | Reboiler |
|---|---|---|---|---|
| Component | Sample #1 | Sample #2 | Sample #3 | contents |
| HCl | 97 wt. % | 97 wt. % | 97 wt. % | 99.5 wt. % |
| HFC-125 | 3 wt. % | 3 wt. % | 3 wt. % | 0.5 wt. % |

As can be seen from the Table 3 data, the higher boiling HFC-125 is separated from the HCl as a low boiling HFC-125/HCl azeotrope-like composition in the overhead distillate of the batch distillation column. As a result, most of the HFC-125 is removed in the light cuts. The reduction of the HFC-125 in the reboiler mixture is a confirmation of the existence of azeotropic mixtures of HFC-125 and HCl at −123° F. (−86° C.).

### Example 4

Vapor-liquid equilibrium data are fed into a UNIFAC model to simulate distillation behavior of the mixture. The results show that distillation of a mixture comprising HCl and an amount of HFC-125 less than the azeotropic amount produces an HCl bottoms product having a reduced content of HFC-125 compared to the original mixture distilled.

What is claimed is:

1. A binary azeotrope-like composition comprising pentafluoroethane and hydrogen chloride.

2. The azeotrope-like composition of claim 1 comprising from about 0.1 to about 10 weight percent pentafluoroethane and from about 90 to about 99.9 weight percent of hydrogen chloride having a vapor pressure of about 30 psia to about 60 psia at −48° C. and about 10 psia to about 20 psia at −85° C.

3. The azeotrope-like composition of claim 1 comprising from about 1 to about 4 weight percent pentafluoroethane and from about 96 to about 99 weight percent of hydrogen chloride having a boiling point of about −123±2° F. at about atmospheric pressure.

4. The azeotrope-like composition of claim 3 comprising about 3 weight percent pentafluoroethane and about 97 weight percent of hydrogen chloride.

5. A method for separating at least one compound selected from the group consisting of pentafluoroethane and hydrogen chloride from a mixture of pentafluoroethane and hydrogen chloride comprising:
providing a mixture comprising pentafluoroethane and hydrogen chloride, said pentafluoroethane or said hydrogen chloride being present in an amount less than the azeotropic amount; and
distilling said mixture to separate the compound present in an amount less than the azeotropic amount as a first product comprising a hydrogen chloride/pentafluoroethane azeotrope-like composition and to produce a second product enriched in the other of said compounds.

6. The method of claim 5 wherein the provided mixture comprises hydrogen chloride and an amount of pentafluoroethane less than the azeotropic amount.

7. The method of claim 6 wherein the provided mixture comprises less than about 10 weight percent pentafluoroethane.

8. The method of claim 7 wherein the provided mixture comprises less than about 3 weight percent pentafluoroethane.

9. The method of claim 8 wherein the provided mixture comprises a crude reactor effluent.

10. The method of claim 9 wherein said crude reactor effluent is produced by a reaction of perchloroethylene and hydrogen fluoride.

11. The method of claim 9 wherein said crude reactor effluent is produced by a reaction of chlorotetrafluoroethane and hydrogen fluoride.

12. The method of claim 9 wherein said crude reactor effluent is produced by a hydrogenation reaction of pentafluoroethane.

13. The method of claim 9 wherein said crude reactor effluent is produced via a vapor phase reaction.

14. The method of claim 9 wherein said crude reactor effluent is produced via a liquid phase reaction.

15. The method of claim 5 wherein the mixture comprising pentafluoroethane and hydrogen chloride comprises a treated reactor effluent.

16. The method of claim 16 wherein the treated reactor effluent is produced by a reaction of perchloroethylene and hydrogen fluoride.

17. The method of claim 16 wherein the treated reactor effluent is produced by a reaction of chlorotetrafluoroethane and hydrogen fluoride.

18. The method of claim 16 wherein said treated reactor effluent is produced via a vapor phase reaction.

19. The method of claim 16 wherein said treated reactor effluent is produced via a liquid phase reaction.

20. The method of claim 5 wherein the provided mixture comprises pentafluoroethane and an amount of hydrogen chloride less than the azeotropic amount.

21. The method of claim 5 further comprising the step of recovering HCl from the column distillate.

22. The method of claim 21 wherein the recovering step comprises extracting HCl from the column distillate with water.

23. The method of claim 21 wherein the recovering step comprises contacting the column distillate with a catalyst to produce a product mixture in which at least a portion of the HFC-125 in the columns distillate is converted into a chlorofluorocarbon; and distilling said product mixture to remove at least a portion of the chlorofluorocarbon.

24. A method for producing purified HCl from a mixture of HFC-125 and HCl comprising:
providing a mixture of HFC-125 and HCl in which the amount of HFC-125 is less than the azeotropic amount;
distilling the mixture to remove the HFC-125 as an azeotrope-like composition of HFC-125 and HCl in a column distillate and to produce a bottoms product enriched in HCl; and
collecting HCl from the bottoms product.

25. The method of claim 24 wherein the mixture comprises an amount of HFC-125 less than about 10 weight percent.

26. The method of claim 24 wherein the mixture comprises an amount of HFC-125 less than about 3 weight percent.

27. The method of claim 24 wherein the collecting step comprises distilling the bottoms to recover HCl.
